(19) United States
(12) Patent Application Publication
(10) Pub. No.: US 2014/0161477 A1
(43) Pub. Date: Jun. 12, 2014

(54) IMAGE FORMING APPARATUS AND CONTROL METHOD

(71) Applicant: CANON KABUSHIKI KAISHA, Tokyo (JP)

(72) Inventor: Tsuyoshi Kurakata, Kawasaki-shi (JP)

(73) Assignee: CANON KABUSHIKI KAISHA, Tokyo (JP)

(21) Appl. No.: 14/094,620

(22) Filed: Dec. 2, 2013

(30) Foreign Application Priority Data
Dec. 12, 2012 (JP) 2012-271780

(51) Int. Cl. G03G 15/00

(52) U.S. Cl. CPC G03G 15/6579
USPC 399/82

(57) ABSTRACT

A print job is executed such that, in a case where single-sided printing is instructed for some pages and double-sided printing is instructed for some pages among multiple pages for which printing instructions have been given according to a print job, and in a case where it has been determined that a conveyance path is present that is different from the conveyance path for double-sided printing and is for reversing the printing sheets front to rear for discharging, the conveyance path for double-sided printing is used in the double-sided printing and the printing sheets are reversed and discharged through the conveyance path for reversing the printing sheets front to rear for discharging in the single-sided printing.

### BACKGROUND OF THE INVENTION

1. Field of the Invention

The present invention relates to image forming apparatuses and control methods in which printing is carried out using a reversing mechanism.

2. Description of the Related Art

Conventionally, in cases where an image forming apparatus is to carry out single-sided printing, after a single side (upper side) of the printing sheet has been printed, the printed surface is outputted face down through a reversing mechanism for reversing the printing sheet so as to maintain the page order. Furthermore, in a case where double-sided printing is to be carried out, after the front surface of the printing sheet has been printed, the printing sheet is passed through a conveyance path for double-sided printing and the rear surface is printed and outputted. Furthermore, image forming apparatuses are known (Japanese Patent Laid-Open No. 2005-15186) in which double-sided printing is carried out by selecting a transport route to increase productivity in a case where multiple conveyance paths are present for double-sided printing.

There are cases where single-sided printing and double-sided printing are mixed within the printing according to a print job that is inputted to the image forming apparatus. In a case where the aforementioned print job is executed and single-sided printing and double-sided printing are to be executed successively, printing is performed for double-sided printing by using the conveyance path for double-sided printing, and for single-sided printing the printing sheet is reversed by the reversing mechanism of the conveyance path for double-sided printing and then discharged.

However, a sufficient paper feeding interval has to be established so that a subsequent printing sheet for double-sided printing does not enter the reversing mechanism and collide with a preceding printing sheet while the printing sheet that has undergone single-sided printing is being reversed by the reversing mechanism, and unfortunately this increases the time until printing is completed.

### SUMMARY OF THE INVENTION

An aspect of the present invention is to eliminate the above-mentioned problems with the conventional technology. The present invention provides an image forming apparatus and a control method that increase efficiency in printing where single-sided printing and double-sided printing are mixed.

The present invention in its first aspect provides an image forming apparatus that has a conveyance path for performing double-sided printing on a printing sheet, and in a case where single-sided printing is to be performed on printing sheets, reverses each of the printing sheets using a reversing mechanism of the conveyance path for double-sided printing and discharges the sheets, comprising: a reception unit configured to receive a print job, a determination unit configured to determine whether or not a conveyance path is present that is different from the conveyance path for double-sided printing and is for reversing printing sheets front to rear for discharging, and an execution unit configured to execute the print job such that, in a case where single-sided printing is instructed for some pages and double-sided printing is instructed for some pages among multiple pages for which printing instructions have been given according to the print job received by the reception unit, and in a case where the determination unit determines that a conveyance path is present for reversing the printing sheets front to rear for discharging, the conveyance path for double-sided printing is used for the double-sided printing, and the printing sheets are reversed and discharged through the conveyance path for reversing the printing sheets front to rear for discharging for the single-sided printing.

The present invention in its second aspect provides a control method of an image forming apparatus to be executed by an image forming apparatus that has a conveyance path for performing double-sided printing on a printing sheet, and in a case where single-sided printing is to be performed on printing sheets, reverses each of the printing sheets using a reversing mechanism of the conveyance path for double-sided printing and discharges the sheets, comprising: a reception step of receiving a print job, a determination step of determining whether or not a conveyance path is present that is different from the conveyance path for double-sided printing and is for reversing printing sheets front to rear for discharging, and an execution step of executing the print job such that, in a case where single-sided printing is instructed for some pages and double-sided printing is instructed for some pages among multiple pages for which printing instructions have been given according to the print job received at the reception step, and in a case where it is determined at the determination step that a conveyance path is present for reversing the printing sheets front to rear for discharging, the conveyance path for double-sided printing is used for the double-sided printing, and the printing sheets are reversed and discharged through the conveyance path for reversing the printing sheets front to rear for discharging for the single-sided printing.

According to the present invention, efficiency can be improved in printing where single-sided printing and double-sided printing are mixed.

Further features of the present invention will become apparent from the following description of exemplary embodiments with reference to the attached drawings.

### BRIEF DESCRIPTION OF THE DRAWINGS

FIG. 1 is a block diagram showing a configuration of a print system.

FIG. 2 is a diagram showing a configuration of an image forming apparatus.

FIG. 3 is a block diagram showing a configuration of a controller.

FIG. 4 is a diagram showing a configuration of a printing sheet transport unit.

FIG. 5 is a diagram showing a situation where printing sheets are simultaneously present on a conveyance path.

FIG. 6A and FIG. 6B are diagrams for describing a paper feeding and printing procedure in a case of double-sided printing.

FIG. 7A and FIG. 7B are diagrams for describing a paper feeding and printing procedure in a case where a reversing path of a post-processing device is to be used.

FIG. 8A and FIG. 8B are diagrams for describing a paper feeding and printing procedure in a case where a reversing path of a post-processing device is not to be used.

FIG. 9 is a flowchart showing a procedure of print processing according to a present embodiment.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. It should be noted that same reference numbers are assigned to same compositional elements and description thereof is omitted.

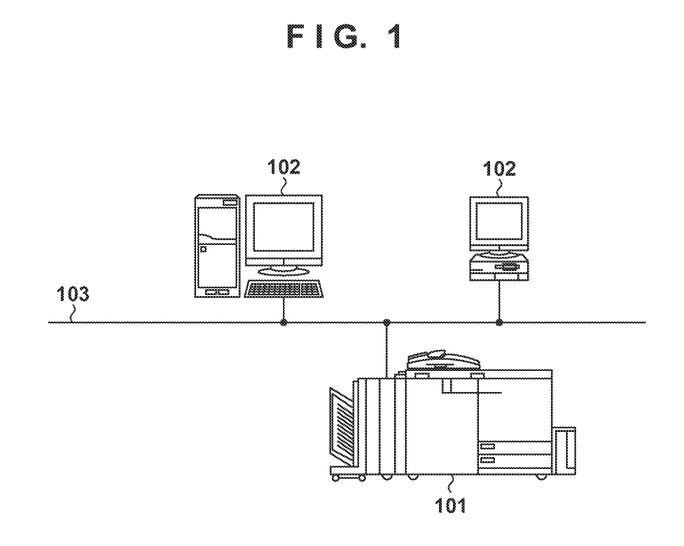

FIG. 1 is a block diagram showing a configuration of a print system including an image forming apparatus according to the present invention. In this print system, a host computer 102 is an ordinary PC for example, and transmits print jobs and print data to an image forming apparatus 101. The image forming apparatus 101 is an ordinary printer provided with a printing function, and carries out printing onto a printing medium (hereinafter referred to as printing sheet) such as a printing sheet or the like according to a print job or print data received from the host computer 102. The image forming apparatus 101 may also be a printer that is capable of being connected to a finisher device or the like, and may also be a multifunction printer (MFP) in which a scanner and a fax or the like are integrated. In the present embodiment, a print job transmitted from the host computer 102 to the image forming apparatus 101 is a print job that gives printing instructions for a document including multiple pages, and single-sided printing is instructed for some of the pages and double-sided printing is instructed for some of the pages. In addition to its function of transmitting print jobs and print data, the host computer 102 is provided with a function of executing image editing processing according to an image processing application. The image forming apparatus 101 and the host computer 102 are communicably connected to each other through a network 103.

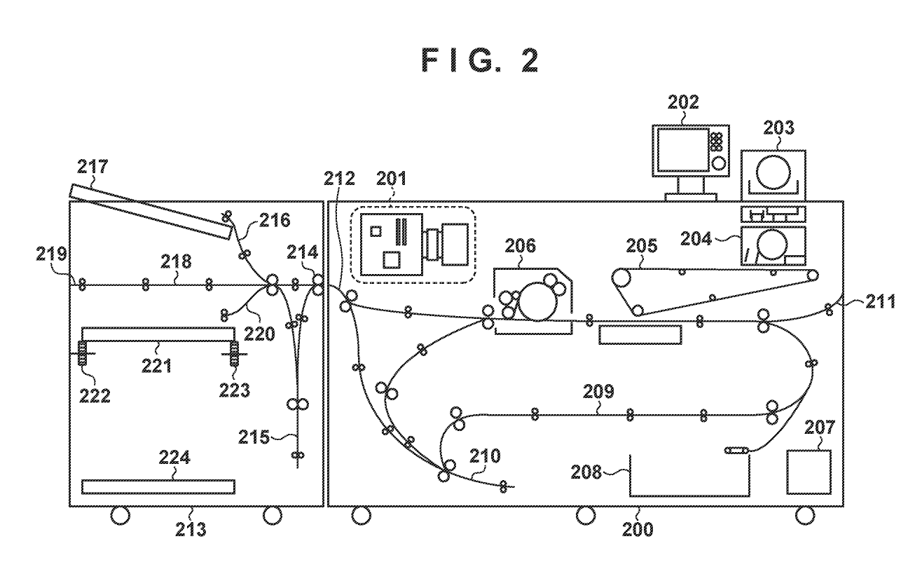

FIG. 2 is a diagram showing a configuration of the image forming apparatus 101. The image forming apparatus 101 is provided with an image forming apparatus main unit 200 and a post-processing apparatus 213. The image forming apparatus main unit 200 carries out printing on the printing sheets that are fed in, and the post-processing apparatus 213 is capable of discharging and stacking large amounts of the printing sheets that have been printed by the image forming apparatus main unit 200. The post-processing apparatus 213 may be provided not only with a discharge function, but also finishing functions such as binding and punching or the like.

A controller 201 of the image forming apparatus main unit 200 performs overall control of the image forming apparatus 101. A console unit 202 is provided with a display and various buttons or the like, and is capable of receiving instructions from the user to image forming apparatus 101. A toner supply unit 203 supplies toner, which is a printing agent, to an image forming unit 204 of the image forming apparatus 101. An opening-closing cover is provided on the toner supply unit 203 such that the user can supply toner through the opening-closing cover.

The image forming unit 204 uses the toner supplied from the toner supply unit 203 to form an image in accordance with the settings of the print job, and transfers this to an intermediate transfer belt 205. The image that has been transferred to the intermediate transfer belt 205 is transferred to a printing sheet. A fixing device 206 fixes the toner to the printing sheet by applying heat and pressure to the printing sheet on which the image has been transferred by the intermediate transfer belt 205. Toner that has not been transferred to the printing sheet by the intermediate transfer belt 205 is stored by an excess toner recovery unit 207.

A paper feeding unit 208 supplies printing sheets to the conveyance path. The printing sheet that is fed from the paper feeding unit 208 is transported (conveyed) to a transfer position by the intermediate transfer belt 205 through a printing sheet transport unit 209, where toner transfer and fixing processing are executed. A switchback unit 210 is a route (reversing mechanism) for enabling the front and back of the printing sheet to be reversed. An input port 211 receives printing sheets that are inputted from outside. A discharge unit 212 discharges the printing sheets that have undergone fixing processing to a post-processing device 213. An input port 214 receives printing sheets that have been inputted from the image forming apparatus main unit 200. A switchback unit 215 is a route (reversing mechanism) for enabling the front and back of the printing sheet to be reversed.

A tray 217 is a tray for receiving printing sheets that have undergone printing. A discharge unit 219 is a discharge unit for discharging the printing sheets to any later stage device. And a stack tray 221 is a stack tray on which printing sheets are stacked. Conveyance paths 216, 218, and 220 are connected to the tray 217, the discharge unit 219, and the stack tray 221 respectively for discharging printing sheets. Motors 222 and 223 move the stack tray 221 up and down, and the printing sheets are discharged outside the device at a discharge position 224.

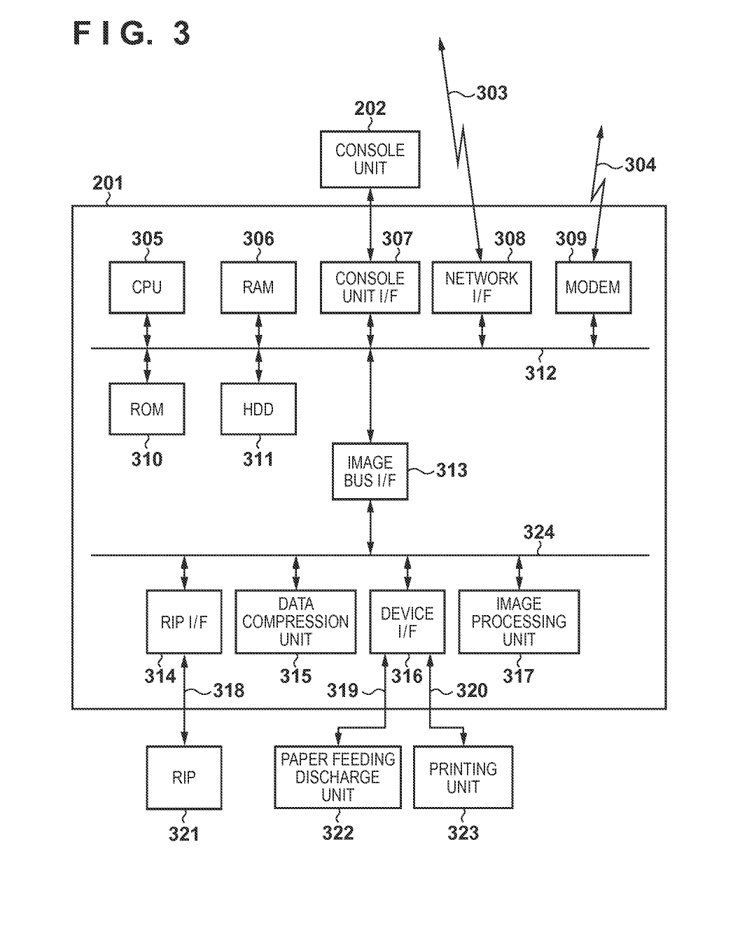

FIG. 3 is a block diagram that shows a configuration of the controller 201. The controller 201 is able to communicate with external devices such as the host computer 102 through a network 303. Furthermore, it is able to carry out telecommunication connections with external devices through a telecommunication line 304. A CPU 305 executes a program for performing overall control of the image forming apparatus 101. A RAM 306 is used as a work area in which the CPU 305 executes the program. Furthermore, the RAM 306 is also used for such purposes as a receiving buffer for temporarily storing data received from outside and as an image data buffer for temporarily storing image data that has been rasterized by a RIP.

A console unit interface 307 functions as an interface for connecting the console unit 202 and the controller 201. A network interface 308 functions as an interface for connecting the controller 201 and the network 303. A modem 309 functions as an interface for connecting the controller 201 and the telecommunication line 304. A ROM 310 stores programs and data and the like to be executed by the CPU 305. A hard disk (HDD) 311 is a nonvolatile storage medium that saves various data necessary for the functioning and execution of the image forming apparatus 101. All these portions from the CPU 305 to the HDD 311 are communicably connected to each other through a CPU bus 312.

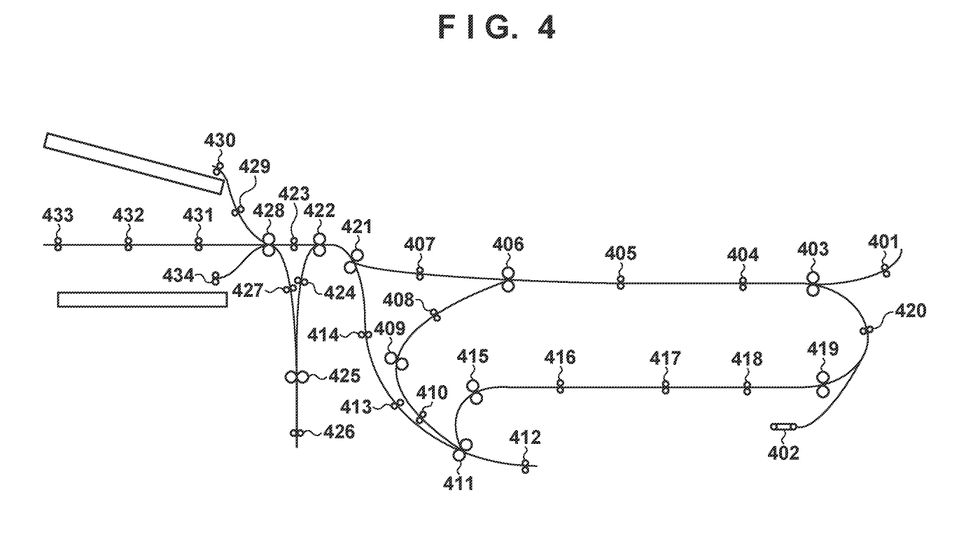

A RIP 321 converts page description data, which is inputted from outside, to bitmap image data. A RIP interface 314 functions as an interface for connecting the RIP 321 and an image bus 324 through an image transfer bus 318. The RIP 321 may also be configured inside the controller 201. A data compression unit 315 executes compression processing on image data and the like and various types of data using a compression system such as JPEG. A device interface 316 functions as an interface for connecting a paper feeding discharge unit 322 and the image bus 324 through a data bus 319. The paper feeding discharge unit 322 includes the printing sheet transport unit 209 and the paper feeding unit 208 shown in FIG. 2 and the transport rollers and the like to be described later in FIG. 4. The device interface 316 functions as an interface for connecting a printing unit 323 and the image bus 324 through a data bus 320. The printing unit 323 includes the toner supply unit 203, the image forming unit 204, and the intermediate transfer belt 205 shown in FIG. 2.

An image processing unit 317 executes various types of image processing such as rotation and editing and the like on the bitmap image data generated by the RIP 321. For example, the image processing unit 317 executes layout processing in which two pages of bitmap image data are composited into one page of bitmap image data. All these portions from the RIP interface 314 to the image processing unit 317 are communicably connected to each other through the image bus 324. An image bus interface 313 functions as an interface for connecting the CPU bus 312 and the image bus 324 and converts the data structure.

In accordance with instruction signals from the console unit 202 or external devices such as the host computer 102 through the network 303, the CPU 305 carries out printing by issuing commands to carry out printing through the data bus 319 or 320 to the printing unit 323 and the paper feeding discharge unit 322.

FIG. 4 is a diagram that shows a configuration of the printing sheet transport unit 209. Portions from a receiving port 401 to a transport roller 421 are configured in the image forming apparatus main unit 200, and portions from a transport roller 422 to a transport roller 433 are configured in the post-processing device 213.

The receiving port 401 is a receiving port for receiving printing sheets that are inputted to the conveyance path from outside. The receiving port 402 is a receiving port for receiving printing sheets that are fed to the conveyance path from the paper feeding unit 208. Transport rollers 403 to 421 are transport rollers provided on the conveyance paths for transporting the printing sheets. Each of the transport rollers 403 to 421 is independently controlled by the controller 201 in accordance with the transport route on which the printing sheet is to be transported. It should be noted that the conveyance path that includes the transport rollers 411 and 412 corresponds to the switchback unit 210 shown in FIG. 2 and the transport rollers 411 and 412 are controlled so as to rotate in reverse when carrying out a switchback operation. Furthermore, a configuration is also provided on the transport rollers 406 and 411 for switching the transport route of the printing sheet.

Transport rollers 422 to 433 are transport rollers provided on the conveyance paths for transporting the printing sheets. As with the transport rollers 403 to 421, each of the transport rollers 422 to 433 is also independently controlled by the controller 201 in accordance with the transport route on which the printing sheet is to be transported. It should be noted that the conveyance path that includes the transport rollers 425 and 426 corresponds to the switchback unit 215 shown in FIG. 2, and the transport rollers 425 and 426 are controlled so as to rotate in reverse when a switchback operation is to be carried out. Furthermore, a configuration is also provided on the transport rollers 422 and 428 for switching the transport route of the printing sheet.

Here, description is given regarding the transport routes of printing sheets in the cases of single-sided printing and double-sided printing respectively. In a case where printing is carried out only on a single side of the printing sheets, which are then discharged with the printed surface face up on the stack tray 221, the controller 201 controls the transport rollers 403, 404, 405, 406, 407, 421, 422, 423, 428, and 434 in order. And due to this control, the printing sheets are transported to the stack tray 221. However, if the printed surfaces are outputted face up in page order, the later pages face upward and are placed on top of the earlier outputted material, and therefore the finished page order is reversed undesirably. Accordingly, the method in which the printed surface is outputted face up is carried out in cases where only one sheet of printing sheet is to be outputted.

On the other hand, there are two methods of carrying out printing on only a single side of the printing sheets and discharging to the stack tray 221 after reversing the printed surface to face down. One of these is a method in which the printing sheets are reversed inside the image forming apparatus main unit 200, and the other is a method in which the printing sheets are reversed inside the post-processing device 213.

In the case of reversing the printing sheets inside the image forming apparatus main unit 200, the controller 201 controls the transport rollers 403, 404, 405, 406, 408, 409, 410, 411, 412, 411, 413, 421, 422, 423, 428, and 434 in order. And due to this control, the printing sheets are transported to the stack tray 221. That is, the printing sheets are reversed in an area of control of the transport rollers 406, 408, 409, 410, 411, 412, 411, 413, and 421 within the image forming apparatus main unit 200. Due to this control, it is possible to discharge the printed surfaces face down onto the stack tray 221. The transport rollers 406, 408, 409, 410, 411, 412, 411, 413, and 421 within the image forming apparatus main unit 200 are referred to as a reversing path inside the image forming apparatus main unit 200.

In the case of reversing the printing sheets inside the post-processing device 213, the controller 201 controls the transport rollers 403, 404, 405, 406, 407, 421, 422, 424, 425, 426, 425, 427, 428, and 434 in order. And due to this control, the printing sheets are transported to the stack tray 221. That is, the printing sheets are reversed in an area of control of the transport rollers 422, 424, 425, 426, 425, 427, and 428 within the post-processing device 213. Due to this control, it is possible to discharge the printed surfaces face down onto the stack tray 221. The transport rollers 422, 424, 425, 426, 425, 427, and 428 within the post-processing device 213 are referred to as the reversing path inside the post-processing device 213.

In the present embodiment, in a case where a specification for single-sided printing and a specification for double-sided printing are mixed within a print job received from the host computer 102, a determination is performed as to whether to use a transport route through either the reversing path of the image forming apparatus main unit 200 or the reversing path of the post-processing device 213. For example, as a criterion of that determination, if the post-processing device 213 in which the reversing path is configured is connected to the image forming apparatus main unit 200, then a transport route is used through the reversing path of the post-processing device 213. On the other hand, if the post-processing device 213 in which the reversing path is configured is not connected to the image forming apparatus main unit 200, then a transport route is used through the reversing path of the image forming apparatus main unit 200. The connection of the post-processing device 213 to the image forming apparatus main unit 200 may be configured so as to be detected by the CPU 305 according to a detection signal from a sensor.

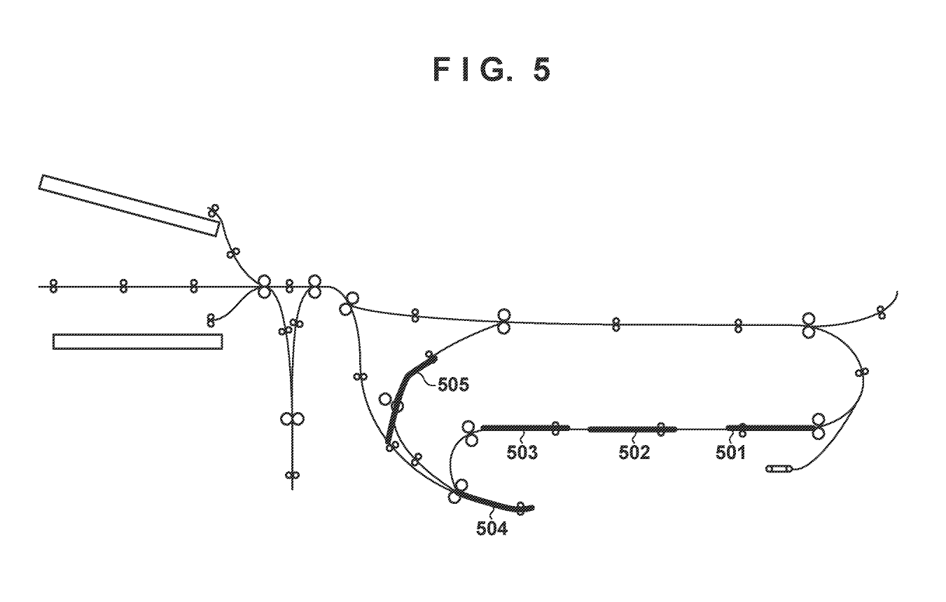

In a case where a transport route is used through the reversing path of the post-processing device 213, the reversing operation of the single-sided printing pages is carried out in the post-processing device 213, and therefore it is possible to use the conveyance path of the image forming apparatus main unit 200 for only the double-sided printing pages. In a case of carrying out double-sided printing, the controller 201 controls the transport rollers 403 to 406, 408 to 410, 411, 412, 411, 415 to 420, 403 to 407, 421 to 423, 428, and 434 in order to transport the printing sheets to the stack tray 221. FIG. 5 is a diagram showing a case where a printing sheet is simultaneously present on the conveyance path during the above-mentioned double-sided printing. As shown in FIG. 5, printing sheets 501 to 505 are standing by on the conveyance path for rear surface printing after printing of the front surface.

If the reversing path of the image forming apparatus main unit 200 is used for single-sided printing pages in a print job in which single-sided printing and double-sided printing are mixed, then unfortunately the positions of the printing sheets 504 and 505 in FIG. 5 become unable to be used as standby positions for double-sided printing. However, if the conveyance path of the image forming apparatus main unit 200 can be used only for double-sided printing pages, then a greater number of standby sheets can be achieved on the conveyance path, thereby enabling printing efficiency to be improved.

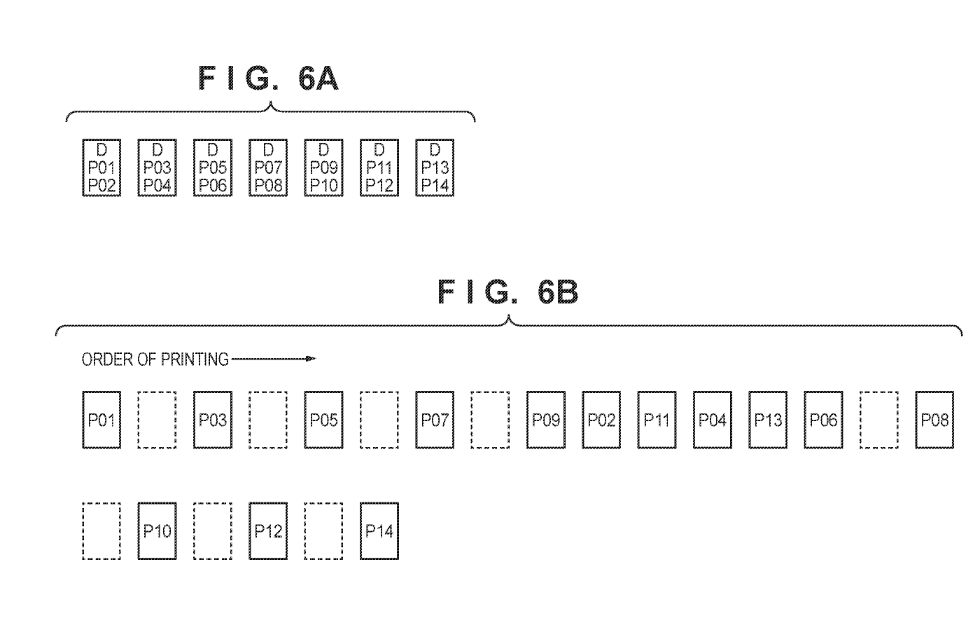

To improve printing efficiency in a case of carrying out double-sided printing, paper feeding from the receiving port 401 or 402 for printing on the front surface and the re-transporting to the transfer position for printing on the rear surface are carried out alternately. For example, in a case of performing double-sided printing for a total of 14 pages as shown in FIG. 6A, and in a case where there are five standby positions as shown in FIG. 5, then the control of paper feeding and printing is carried out as shown in FIG. 6B. That is, as shown in FIG. 6B, the first, third, fifth, seventh, and ninth pages are fed onto the conveyance path and printed with a one-page interval prior to the printing of the second page. And from the timing of the printing of the second page, the printing of the front surfaces according to paper feeding from the receiving port 401 or 402 for printing on the front surface and the printing of the rear surfaces are carried out alternately. The timing of re-transporting the printing sheet on which the first page has been printed to the transfer position, which is the timing by which the second page is printed, is an eight-page interval away in FIG. 6B, but this may vary according to such factors as the length of the conveyance path.

In a case where single-sided printing and double-sided printing are mixed, it is necessary to discharge in page order, and therefore printing sheets that have undergone single-sided printing are reversed and discharged with the printed surface face down. As mentioned above, in the present embodiment, in a case where a reversing path is configured inside the post-processing device 213, the reversing operation is carried out in the post-processing device 213. And the route of the transport rollers 406, 408, 409, 410, 411, 412, 411, 413, and 421 of the image forming apparatus main unit 200 is used for standby positions for double-sided printing. That is, the positions of the printing sheets 501 to 505 in FIG. 5 are used as standby positions for double-sided printing.

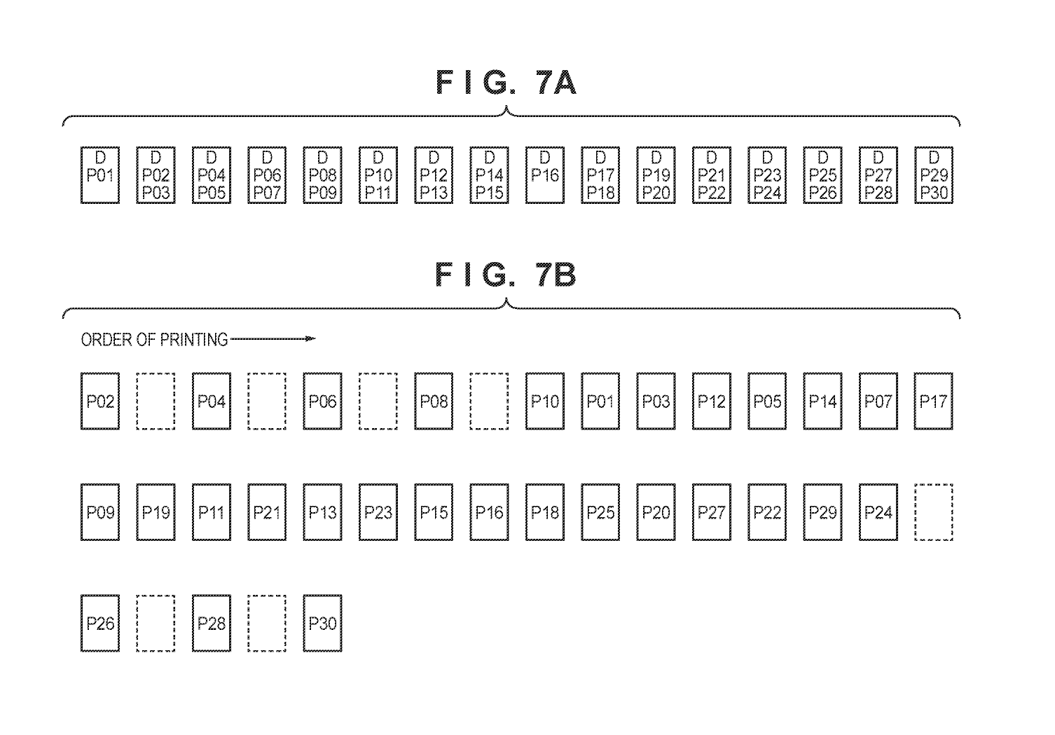

Description is given regarding a case where a reversing path is configured within the post-processing device 213 and, as shown in FIG. 7A, printing is to be carried out according to a print job in which single-sided printing and double-sided printing are mixed. As shown in FIG. 7A, single-sided printing is to be carried out for the first page and the sixteenth page, and double-sided printing is to be carried out for the other pages. FIG. 7B is a diagram for describing the control of paper feeding and printing in this case, and the arrow indicates the order of printing. As shown in FIG. 7B, the second, fourth, sixth, eighth, and tenth pages are printed before the printing of the first page. In the present embodiment, the timing from paper feeding from the receiving port 401 or 402 until re-transporting to the transfer position is set to at least an eight page interval. As in the description according to FIGS. 6A and 6B, at the time point when the tenth page is printed, the printing sheet on which the second page has been printed is present at the standby position (printing sheet 501), which is to be re-transported to the transfer position. Consequently, the printing of the first page is carried out following on from the printing of the tenth page. And following this, the third page is printed onto the rear surface of the printing sheet on which the second page has been printed. And for pages 12, 5, 14, 7, 17, 9, 19, 11, 21, 13, 23, and 15, the printing of the front surfaces according to paper feeding from the receiving port 401 or 402 for printing on the front surface and the printing of the rear surfaces are carried out alternately. When the fifteenth page is to be printed, the sixteenth page undergoes single-sided printing. At the time point when the sixteenth page has been printed, an eight page interval has elapsed since the seventeenth page has been printed, and therefore printing of the eighteenth page is carried out. Subsequently, for pages 25, 20, 27, 22, 29, 24, 26, 28, and 30, the printing of the front surfaces according to paper feeding from the receiving port 401 or 402 for printing on the front surface and the printing of the rear surfaces are carried out alternately.

The printing sheets shown in FIG. 7B on which the first page and the sixteenth page have undergone single-sided printing are discharged to the stack tray 221 through the reversing path of the post-processing device 213. Consequently, the reversing path of the image forming apparatus main unit 200 is not used, and therefore more standby positions can be achieved during double-sided printing and printing efficiency can be improved.

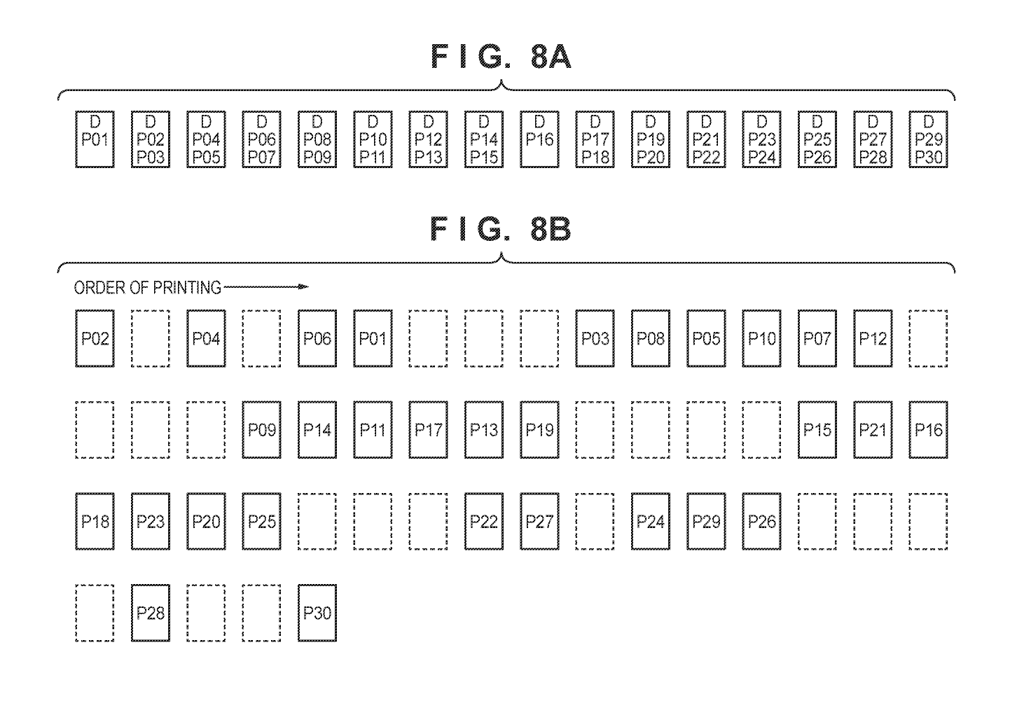

Next, description is given regarding a case where a reversing path is not configured within the post-processing device 213 and, as shown in FIG. 8A, printing is to be carried out according to a print job in which single-sided printing and double-sided printing are mixed. FIG. 8A is identical to FIG. 7A. FIG. 8B is a diagram for describing the control of paper feeding and printing, and the arrow indicates the order of printing. In the present example, the reversing path within the image forming apparatus main unit 200 is used for the printing sheets of the first page and the sixteenth page that have undergone single-sided printing, and therefore the standby positions that are usable during double-sided printing are only the positions of the printing sheets 501 to 503 shown in FIG. 5.

Accordingly, as shown in FIG. 8B, the second, fourth, and sixth pages are printed before the printing of the first page. In the present embodiment, the timing from paper feeding from the receiving port 401 or 402 until re-transporting to the transfer position is set to an eight page interval. After the sixth page has been printed, the first page is printed. Then, after the eight page interval from the printing of the second page, the third page is printed on the rear surface of the second page. And for pages 8, 5, 10, 7, 12, 9, 14, 11, 17, 13, 19, 15, and 21, the printing of the front surfaces according to paper feeding from the receiving port 401 or 402 for printing on the front surface and the printing of the rear surfaces are carried out alternately. The fifteenth page is printed immediately before the printing of the twenty-first page, and therefore single-sided printing is performed for the sixteenth page following on from after the twenty-first page has been printed. Subsequently, for pages 18, 23, 20, 25, 22, 27, 24, 29, 26, 28, and 30, the printing of the front surfaces according to paper feeding from the receiving port 401 or 402 for printing on the front surface and the printing of the rear surfaces are carried out alternately. As is evident from FIG. 8B and FIG. 7B, the time until the printing of all pages is completed is shorter for FIG. 7B.

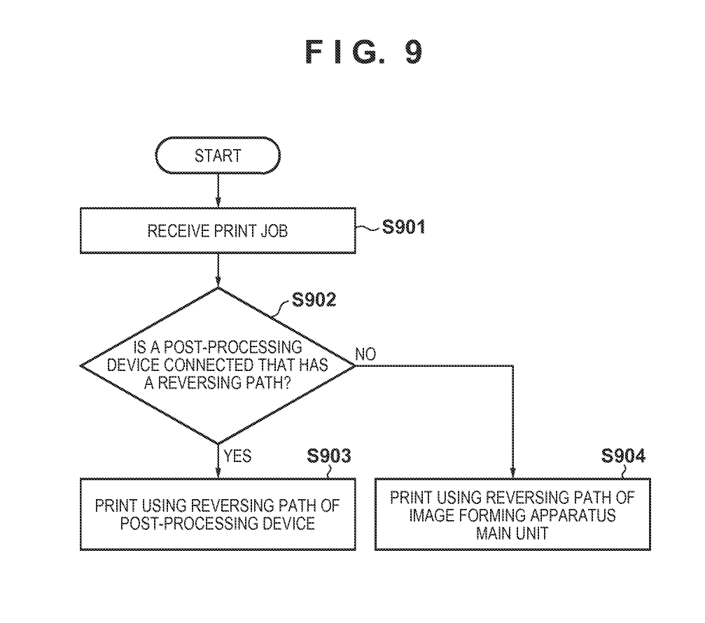

FIG. 9 is a flowchart showing a procedure of print processing according to the present embodiment. The processing shown in FIG. 9 is executed for example according to the control performed by the CPU 305 on the units of the image forming apparatus 101. First, the CPU 305 receives a print job and print data from the host computer 102. Here, it is given that the print job is a print job for executing printing of a document including multiple pages, and is a print job in which instructions for single-sided printing and instructions for double-sided printing are mixed (S901). Next, in executing the printing according to the received print job, a determination is performed (S902) as to whether or not a post-processing device 213 having a reversing path is connected. Here, in a case where it is determined that this is connected, printing is carried out at S903 using the reversing path of the post-processing device 213 for the pages of single-sided printing. The procedure of paper feeding and printing at S903 is the same as described in FIGS. 7A and 7B. In a case where it is determined at S902 that this is not connected, printing is carried out at S904 using the reversing path of the image forming apparatus main unit 200 for the pages of single-sided printing. The procedure of paper feeding and printing at S904 is the same as described in FIGS. 8A and 8B.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-271780, filed Dec. 12, 2012, which is hereby incorporated by reference herein in its entirety.

What is claimed is:

1. An image forming apparatus that has a conveyance path for performing double-sided printing on a printing sheet, and in a case where single-sided printing is to be performed on printing sheets, reverses each of the printing sheets using a reversing mechanism of the conveyance path for double-sided printing and discharges the sheets, comprising:
a reception unit configured to receive a print job,
a determination unit configured to determine whether or not a conveyance path is present that is different from the conveyance path for double-sided printing and is for reversing printing sheets front to rear for discharging, and
an execution unit configured to execute the print job such that, in a case where single-sided printing is instructed for some pages and double-sided printing is instructed for some pages among multiple pages for which printing instructions have been given according to the print job received by the reception unit, and in a case where the determination unit determines that a conveyance path is present for reversing the printing sheets front to rear for discharging,
the conveyance path for double-sided printing is used for the double-sided printing, and the printing sheets are reversed and discharged through the conveyance path for reversing the printing sheets front to rear for discharging for the single-sided printing.

2. The image forming apparatus according to claim 1, wherein in a case where single-sided printing is instructed for some pages and double-sided printing is instructed for some pages among multiple pages for which printing instructions have been given according to the print job received by the reception unit, and in a case where the determination unit determines that a conveyance path is not present for reversing the printing sheets front to rear for discharging, the execution unit executes the print job such that the conveyance path for double-sided printing is used for the double-sided printing and that the printing sheets are reversed and discharged by a reversing mechanism of the conveyance path for double-sided printing for the single-sided printing.

3. The image forming apparatus according to claim 1, wherein for the double-sided printing, the execution unit alternately performs sheet by sheet printing for a front surface of the printing sheet and printing for a rear surface of a printing sheet whose front surface has already been printed.

4. The image forming apparatus according to claim 1, wherein the determination unit performs a determination according to whether or not a device that has a conveyance path for reversing the printing sheets front to rear for discharging and that is different from the image forming apparatus is connected to the image forming apparatus.

5. A control method of an image forming apparatus to be executed by an image forming apparatus that has a conveyance path for performing double-sided printing on a printing sheet, and in a case where single-sided printing is to be performed on printing sheets, reverses each of the printing sheets using a reversing mechanism of the conveyance path for double-sided printing and discharges the sheets, comprising:
a reception step of receiving a print job,
a determination step of determining whether or not a conveyance path is present that is different from the conveyance path for double-sided printing and is for reversing printing sheets front to rear for discharging, and
an execution step of executing the print job such that, in a case where single-sided printing is instructed for some pages and double-sided printing is instructed for some pages among multiple pages for which printing instructions have been given according to the print job received at the reception step, and in a case where it is determined at the determination step that a conveyance path is present for reversing the printing sheets front to rear for discharging, the conveyance path for double-sided printing is used for the double-sided printing, and the printing sheets are reversed and discharged through the conveyance path for reversing the printing sheets front to rear for discharging for the single-sided printing.
